(19) United States
(12) Patent Application Publication
(10) Pub. No.: US 2005/0216524 A1
(43) Pub. Date: Sep. 29, 2005

(54) Smart and selective synchronization between databases in a document management system

(75) Inventors: David Gomes, Santa Monica, CA (US); Duke Fong, San Gabriel, CA (US); Adrian Roston, Encino, CA (US)

Correspondence Address: MCDERMOTT WILL & EMERY LLP;Suite 3400, 2049 Century Park East, Los Angeles, CA, 90067, US

(73) Assignee: Integrated Data Corporation

(21) Appl. No.: 10/987,373

(22) Filed: Nov. 12, 2004

Related U.S. Application Data
(63) Continuation-in-part of application No. 10/807,032, filed on Mar. 23, 2004.

(51) Int. Cl. G06F 17/30; G06F 12/00

(52) U.S. Cl. 707/201

(57) ABSTRACT

A smart synchronization method and system for use in a document management system is disclosed. Upon a request for data synchronization from a remote location, the management software determines, based on network parameters and data types, the most effective algorithms for efficiently transporting the data to be synchronized over the network. In another aspect, a selective synchronization method and system is disclosed wherein the management software uses a summary of data in a request for synchronization to determine which data sets require updating. The management software synchronizes the databases using only those updates, rather than entire data sets. Network efficiency is maximized as a result.

### BACKGROUND

### RELATED APPLICATION DATA

This application is a continuation-in part of U.S. patent application Ser. No. 10/807,032, filed Mar. 23, 2004, entitled “Multi-Tier Document Management System,” attorney docket no. 66470-011. The content of this application is incorporated herein by reference.

### BACKGROUND OF THE INVENTION

1. Field of the Invention

The present invention relates generally to data management, and more specifically to a method and system for synchronizing data over networks.

2. Description of Related Art

The proliferation of data and document management systems has soared in recent years. Document management systems generally provide a centralized repository for a related group of users to create and edit a relevant body of documentation. Such an example would include a corporation with multiple locations working on common document types. Typical document systems enable multiple users to “work” on a related set of documents, and save the updates or revisions. Such document systems generally utilize networking capabilities for expanded functionality and simultaneous accessibility by multiple users. Updated documents are available at various locations. These systems ordinarily include a centralized location where the server computer (or array of computers) is located. The server, or set of servers, often contains a sophisticated array of memory banks in which to house the various documents. Users at remote locations can access and, assuming they have applicable permissions, can edit and update the documents. The updated documents are usually stored in the central repository. The array of servers typically forms one logical entity, even though a number of networked memory banks may be involved.

The movement of data—documents and otherwise—presents a challenge with respect to current systems. Documents and other data, such as pictures, movie files, text and symbol-formatted data, schematics, diagrams, etc., often need to be synchronized over a network between data repositories. Generally, synchronization refers to the transfer, update, conversion, and/or integration of data between repositories. Synchronization helps ensure that data residing in various repositories of the management system is the most up-to-date available. As changes and updates to documents or data are regularly made in a typical data management system, synchronization of the data across the various repositories helps provides users with the latest documents and versions at any given time.

In the example where a user at a remote location has a local memory bank in which the user retrieves documents and edits them at a remote location, the synchronization process in one configuration takes place when the user “saves” the edited file back onto a local server. Thereupon, a second user at a remote site can access the most recent file from the local server and download it to the second user's computer to view its contents.

More elaborate data management systems may exist which require regular synchronizations of data, or which require the leasing or purchase of potentially expensive network resources to move data from one location to another. In some applications, a user at a remote site may request a set of synchronized data from a master database. The master database may respond by transmitting an updated version of the data requested by the remote site over the network. Synchronization may be bi-directional, with the master data repository(ies) moving data over one or more networks or connections to local repositories, and vice versa. Data synchronization may be performed manually, or it may be an automatic or scheduled process. In addition, a separate broker or intermediary component may be responsible for scheduling or performing synchronizations between two locations.

Synchronization procedures consume bandwidth. When data is updated over networked systems, the updated data may consume a large amount of network resources. The problem is exacerbated where network resources are limited or where network bandwidth is being leased. A more general problem exists in that networks are unduly taxed by excessive traffic, particularly where regular synchronizations are necessary for the operation of a sophisticated data management system. In the case where network resources are limited relative to the bandwidth required for data transfers, the synchronization process can be unacceptably slow.

Different types of files present different challenges for synchronization and bandwidth purposes. More specifically, a particular type of file (e.g., a text file, audio file, etc.) is generally associated with different characteristics. That is, different file or data types may use different types of formats, compression schemes, protocols, and metadata. It is desirable to synchronize data and files over networks in as efficient a manner as possible in light of the limitations on networking capability. Different types of files can be transferred more efficiently over a network using algorithms or protocols that are specific to those file types.

However, present synchronization systems generally are not designed to differentiate between the different file types and associated metadata when performing synchronization operations. Instead, generally a single or limited set of file manipulation algorithms are performed for each synchronization. Upon synchronization, different file types are consequently transmitted over the networks in a data management system that uses a common underlying protocol or set of algorithms to initiate and execute the movement of the data. For many file types, the common underlying algorithm(s) may result in extremely poor efficiency of transmission over the network. The result is often a synchronization technique with less than exemplary network performance characteristics.

As an illustration, an xml type data file contains different characteristics and distinct types of metadata over that of a regular text file, or a movie file. Different compression and reduction algorithms may be useful to take advantage of these distinct characteristics when transmitting and receiving such files over a network. Movie files may require the use of effective compression schemes such as those based on MPEG-2, MPEG-4 or H.264 standards, etc. Text or graphics files may also require distinct synchronization or compression techniques to generate maximum efficiency and minimal transfer times. In addition, the type of network connection (such as a low versus high bandwidth channel) may dictate that different synchronization schemes be applied to different data to maximize the efficiency of data transfer over that particular network.

As noted above, existing synchronization systems generally do not differentiate between data types. That is, these systems do not provide mechanisms that establish how data is to be transferred over a network for maximum efficiency. Such systems also do not take advantage of the use of synchronization algorithms unique to the file and/or optimized for transmission over a network type. Instead, data is typically transferred over a network in these existing systems using a universal synchronization algorithm that does not consider file types or characteristics of different data.

Accordingly, a need exists in the art for a synchronization mechanism that takes into consideration how data is to be replicated to distant locations, in light of, for example, file types, network characteristics, and bandwidth constraints.

### SUMMARY OF INVENTION

In one aspect of the present invention, a method to synchronize data between a local database and a remote database over one or more networks includes receiving a synchronization request, identifying data types to be synchronized, selecting, based on the data types to be synchronized, one or more algorithms for efficiently transporting data corresponding to the data types to be synchronized over the one or more networks, and synchronizing the data between the local database and the remote database over the one or more networks.

In another aspect of the present invention, a method to synchronize data in a document management system, the document management system including a data repository (DR) component, a data replication store (DRS) for storing data at a location remote from the DR component, and a data management component (DMC), including receiving, from the DRS, a request to synchronize data between the DRS and the DR, identifying, by the DMC, the types of data to be synchronized, selecting, by the DMC, one or more algorithms for efficiently transmitting the data types to be synchronized across one or more networks to which the DR, DMC and DRS are coupled, and synchronizing data corresponding to the data types over the network.

In still another aspect of the invention, a document management system includes a data repository (DR) component comprising a master repository for storing data, a data replication store (DRS) component including one or more local data units for storing data sets, each data set originating at least in part from the data in the logical master repository and including information applicable to a corresponding one of the local data units, and a data management component (DMC) including a synchronization service for transferring updated data from the master repository to the one or more local data units via one or more networks, wherein the synchronization service, upon request for a synchronization by the DRS, analyzes the data types to be transferred and then transmits data corresponding to the data types using one or more algorithms for efficiently transferring the data across the one or more networks.

In still another aspect of the invention, a three-tier document management system for use by an entity comprising a plurality of end user groups, the system including a data repository (DR) tier comprising a content management system for storing data in a master repository, a data replication store (DRS) tier comprising a plurality of data units which correspond respectively to each of the plurality of end user groups, and a data management component (DMC) tier for mediating the synchronization of data between the data repository (DR) tier and the data replication store (DRS) tier, wherein, upon request for synchronization issued from a DRS tier, the DMC tier is configured to analyze data types to be synchronized, select one or more algorithms for enabling an efficient synchronization of data over one or more networks coupling the DR tier to the DRS tier, and perform the synchronization of the data using the one or more algorithms.

In still another aspect of the invention, a document management system for managing the storage and transfer of data includes data repository (DR) means for providing a master data repository for storing and managing data, data replication store (DRS) means for providing one or more data units, each data unit for storing information originating at least in part from the data in the master data repository, and data management component (DMC) means for maintaining records relevant to a state of each of the one or more data units and for performing a smart synchronization of the data in the data repository (DR) means with the information in the one or more data units in the data replication store (DRS) means.

In still another aspect of the invention, computer-readable media embodying a program of instructions executable by a computer program to perform a method to synchronize data between a local database and a remote database over one or more networks includes receiving a synchronization request, identifying data types to be synchronized, selecting, based on the data types to be synchronized, one or more algorithms for efficiently transporting data corresponding to the data types to be synchronized over the one or more networks, and synchronizing the data between the local database and the remote database over the one or more networks.

Other embodiments of the present invention will become readily apparent to those skilled in the art from the following detailed description, wherein it is shown and described only certain embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

Aspects of the present invention are illustrated by way of example, and not by way of limitation, in the accompanying drawings, wherein:

FIG. 1 is an illustration of a multi-tier document management system in accordance with an embodiment of the present invention.

FIG. 2 is an illustration of a multi-tier document management system in accordance with another embodiment of the present invention.

FIG. 3 shows an example of a user search engine web interface in accordance with an embodiment of the present invention.

FIG. 4 is an example of a user interface in accordance with an embodiment of the present invention.

FIG. 5 is an example of a user interface for facilitating the manual synchronization of documents in accordance with an embodiment of the present invention.

FIG. 6 is an example of a web-based user interface that provides a login screen in accordance with an embodiment of the present invention.

FIG. 7 is an example of a web-based user interface for providing information regarding the document management system in accordance with an embodiment of the invention.

FIG. 8 is a block diagram of a system for performing smart and selective synchronization in accordance with an embodiment of the invention.

FIG. 9 is a conceptual illustration of the smart synchronization method in accordance with an embodiment of the present invention.

FIG. 10 is a conceptual illustration of the selective synchronization method in accordance with an embodiment of the present invention.

FIG. 11 is a block diagram of a system configured to perform smart synchronization in accordance with an embodiment of the present invention.

FIG. 12 is a block diagram of a data management system employing the smart synchronization techniques in accordance with an embodiment of the present invention.

FIG. 13 is a block diagram of an exemplary system for performing smart synchronization in accordance with an embodiment of the present invention.

FIG. 14 is a block diagram of a plurality of nodes which are part of a distributed system for performing document management operations in accordance with an embodiment of the present invention.

FIG. 15 is a block diagram of a plurality of nodes which are part of a distributed system for performing document management operations and using disparate platforms in accordance with an embodiment of the present invention.

FIG. 16 shows a block diagram of another configuration of the document management system for performing smart and/or selective synchronization in accordance with an embodiment of the present invention.

### DETAILED DESCRIPTION OF ILLUSTRATIVE EMBODIMENTS

The detailed description set forth below in connection with the appended drawings is intended as a description of various embodiments of the present invention and is not intended to represent the only embodiments in which the present invention may be practiced. Each embodiment described in this disclosure is provided merely as an example or illustration of the present invention, and should not necessarily be construed as preferred or advantageous over other embodiments. The detailed description includes specific details for the purpose of providing a thorough understanding of the present invention. However, it will be apparent to those skilled in the art that the present invention may be practiced without these specific details. In some instances, well-known structures and devices are shown in block diagram form in order to avoid obscuring the concepts of the present invention.

The software platform as disclosed herein may enable one or more users to tailor, maintain, and distribute various data types (including sensitive or secret data) to and from a centralized repository and various remote data units. In one embodiment, the platform of the present invention is designed to provide uniform content management, document versioning, knowledge distribution to specified users, and digital content manipulation. The platform can be constructed as a series of layered software routines. The platform provides a standardized document and control system that allows for the manipulation of formats and controlled distribution of data. The platform also may feature an advanced content management and control system architecture that allows for manipulation of data at the sub-document or information object level.

The enterprise solution according to the present invention includes a multi-tier configuration. The platform includes a “data management component (DMC)” between the end user and the master repository, or the various other user repositories. Among other attributes, the data management component (DMC) enables an administrator to build, construct, and maintain indices to the data in the master repository and/or the data units. The data management component (DMC) may assemble a user digital technical data library collection (or update to an existing library) based on chosen data objects, and the needs and permissions of the user can be identified by a predefined user profile. The data management component (DMC) can then transmit this collection of technical data (or updates) to the user site as necessary or appropriate. The user can access a web-based or other portal to access this data. The portal management system may provide a common user interface that dynamically produces updates and management functions to personalize the data dictated by the user profile. Moreover, the platform in certain configurations may permit a local line management in a particular unit or corporation to manage and modify selected components of the portal interface. In one embodiment, a user-friendly document viewer displays documents, regardless of format, in a standard template. The template allows, among other benefits, standardized document searches. The portal in this implementation also provides drop-down menus for associated checklists generated by the entity. A frame for the user's further customization of the platform may also be provided.

Generally, document management is a complex subject covering the complete lifecycle of a document including its creation, edition, updates, revision management, viewing, and obsolescence. A document management system and method according to the present invention is divided into multiple tiers of cooperating components. This division enables more intelligent data flow and control, more centralized management of user profiles for sensitive or complex applications, and greater efficiency in day-to-day operations.

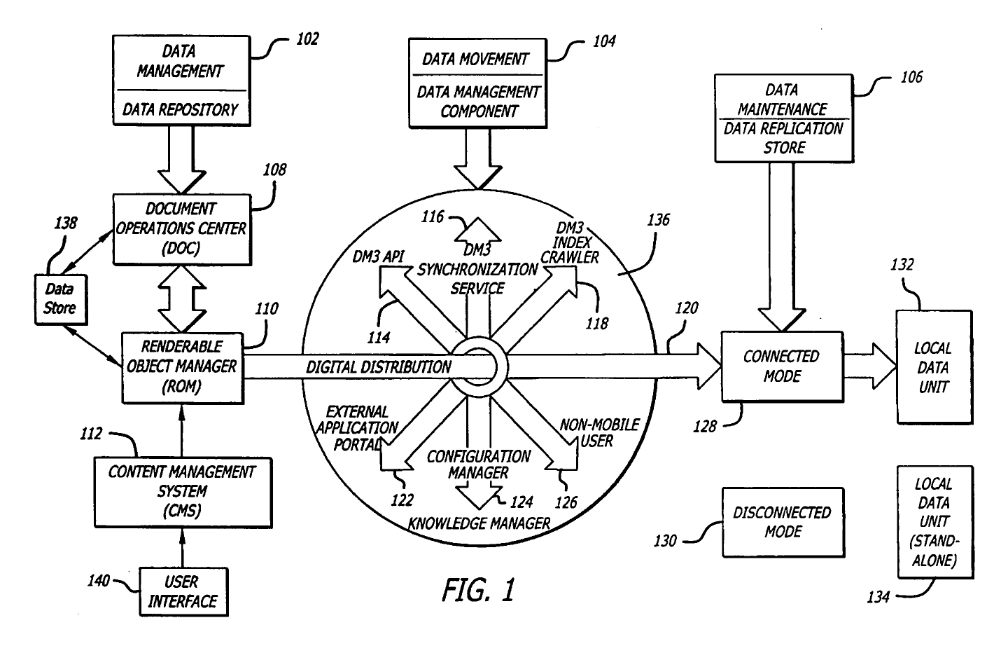

FIG. 1 is an illustration of a multi-tier document management system according to an embodiment of the present invention. The system in FIG. 1 includes three principle tiers: (i) the data management (data repository (DR)) tier 102; (ii) the data movement (data management component (DMC)) tier 104; and (iii) the data maintenance (data replication store (DRS)) tier 106. The data management tier 102 maintains one or a plurality of databases which generally constitute a centralized repository for the data pertinent to a particular customer, such as a corporation, partnership, government agency, military entity, etc. The data management tier 102 includes a master document repository including, in one embodiment, a document operations center 108, renderable object manager 110, content management system 112, and data store 138. The data store 138 constitutes the primary repository for all data and control information needed to populate the end-user digital libraries.

As illustrated below, the specific hardware requirements of the data store are generally dependent upon the needs of the customer and the application(s) at issue. Data store 138 is ordinarily redundant in nature, and includes protection from memory or hardware faults. Data store 138 is also referred to as a logical master repository or data repository (DR). The data repository (DR) maintains the centralized sets and families of data for a particular customer, keeping track of the revision history of documents.

The content management system 112 generally controls access to the data store 138. While seen as a separate component in this example, the content management system 112 may include or encompass part or all of the functionality of other blocks, such as the renderable object manager 110 and the document operations center 108. Data and/or document revisions, insertions, additions, updates, deletions, removals, etc., may be handled through the content management system 112. In some implementations, the content management system 112 may be coupled to a user interface 140 such as a web service. The web service may have a published markup language that can be used by the customer for interfacing with the data store 138. As discussed further below, communication with the content management system 112 can occur locally, or over a TCP/IP network. Through the vehicle of the content management system 112, documents can be added to or removed from data store 138, and searches can be performed based on various criteria input by the user or by an application. In some embodiments, the user interface may be considered to be a part of the renderable object manager 110. In other configurations, different types of user interface capabilities may be included within the different software layers.

A document operations center 108 may also be included which allows for the manipulation of documents within data store 138. The document operations center 108 is generally intended to encompass a wide range of capabilities for manipulating or modifying data contained in the data store 138. Many of these capabilities are dependent upon the applications and needs of the customer. In general, revisions may be updated, and revision histories may be maintained or controlled within this entity. A search engine and indexing functionality may also be provided in document operations center 108. Renderable object manager (ROM) 110 provides data to data store 138 and mediates between the data management tier 102 and the data movement tier 104. ROM 110 may include an indexer, user interface, or data provider interface for transmitting data from an external source to data store 138. ROM 110 may allow a user to enter data into the data store 138 through the content management system 112. ROM 110 also may provide a pipe 120 for the distribution of digital data through a data management component (DMC) tier 104 to a data replication store (DRS) tier 106.

In some configurations, the content management system 112 may generally include the functionality of the renderable object manager 110 and the document operations center 108. Further, in some embodiments, data from the data replication store (DRS) tiers 106 may be sent via the data management component (DMC) tier 104 up to the data store 138 for storage, as through pipe 120 or through another mechanism.

One objective of the data management tier 102 is to ensure that the latest updated relevant information is timely provided to the end user. Accordingly, the data management tier 102 may include: capabilities for document management such as creation, updates, deletes, revisions, etc.; one or more document search engines for accessing the data in master repository 138 and for identifying documents based on key words or phrases; identifying document applicability to users based on appropriate roles and permissions (as defined or maintained in some embodiments in the data management component (DMC) tier 104); maintaining document security by requiring digital certificates, authentication, encryption, or other means; allowing manual or automatic updates to information in master repository 138 through content management system 112 and user interface 140; handling disparate document types; optimizing bandwidth in the case of synchronizations; providing document access at all times; providing flexibility in document revision management schemes; and maintaining document sets and inter-related families.

A data movement or data management component (DMC) tier 104 is also provided. For clarification, the DMC tier 104 is distinct from the data management tier 102. In one embodiment, the data management component (DMC) tier 104 (as exemplified by the functionality and components set forth in knowledge manager 136) mediates between the data repository environment tier 102 containing the master repository (i.e., data store 138 and associated interfacing tools) on one hand, and the data replication tiers 106 on the other hand. More specifically, the data management component (DMC) tier 104 manages the end user sites (e.g., local data unit 132) in accordance with changes received from the data repository (DR) tier 102. The data management component (DMC) tier 104 includes a DM3 synchronization service 116 which may be coupled through a network or other intermediary mechanism to the data repository (DR) tier 102 and one or more data replication store (DRS) tiers 106. The DM3 synchronization service may perform and manage changes at the byte-level and may also perform automatic synchronizations of data according to a particular configuration management solution. In turn, data can be synchronized only to networks or data replication store (DRS) tiers 106 that require the data, thereby potentially saving significant bandwidth over systems that simply transmit synchronization information to all connected data units. For the purposes of this disclosure, the term “DM3” generally refers to actions performed for or on behalf of (but not necessarily by) the data maintenance or data replication store (DRS) tier 106. For example, because synchronization is a process which provides updates contained in data store 138 to data units 132 in data replication store (DRS) tier 106, the synchronization service according to this embodiment is considered a DM3 synchronization service 116.

As can be seen from FIG. 1, the data management component (DMC) environment 104 may include several individual services that collectively provide an overall knowledge management function. These functions may be separate entities, but they generally are built on software layers designed to function together in order to perform the necessary tasks of the data management component (DMC) 104.

Data management component (DMC) environment tier 104 includes in one embodiment a knowledge manager layer 136. The knowledge manager 136 is associated with two major functions that, in some configurations, work in conjunction with one another. A Global Knowledge Manager (GKM) (not shown) installs at a base location and is administrated by the base command, and a Local Knowledge Manager (not shown) installs at a unit location. The GKM and LKM, described in greater detail below, may be very close organizationally and physically to the operational units. Generally, the LKM permits local modification of the digital library by the unit. The GKM may constitute a parent node, upon which the LKM child node depends to determine the latest data available for the unit.

As noted above, the knowledge manager 136 includes a synchronization service 116. The synchronization service performs data synchronization between the GKM and the LKM and the GKM and the data repository (DR). In some configurations, the synchronization service 116 identifies the applicable LKM (and corresponding unit) by its profile. Based on this profile, the synchronization service identifies the applicable documents, renderable objects and database records necessary to make a complete digital library for the LKM to be synchronized. The synchronization service is discussed in greater detail, below.

The knowledge manager 136 also includes a configuration manager 124. The configuration manager constitutes a collection of software routines that is responsible for identifying the data applicable to a specific end user in the data replication environment 106. A hashed mapping may be maintained between data sets and end users. The configuration manager 124 may reference this mapping when identifying applicable data sets. As discussed below, the configuration manager 124 may in one embodiment be accessible through a web service. Access to the configuration manager 124 can be made through an administration user interface, or directly through the web service interface.

The knowledge manager 136 also may include a DM3 index crawler 118. In some implementations, the index crawler constitutes a software-based service that identifies the current location and revision of the data managed by the knowledge manager 136. For example, the synchronization service 116 may monitor all data relevant to a profile at a particular user site and then use the index crawler 118 functionality to identify and synchronize any data being added, modified or deleted at the data store associated with the user site at issue. The knowledge manager 136 may also include a DM3 API 114. The API (application programming interface) 114 provides a defined interface so that other programs, such as third party programs used by the customer, can access the capabilities of the knowledge manager 136. The API 114 provides user-friendly access by the customer to the various attributes and capabilities associated with the knowledge manager 136. Similarly, an external application portal 122 and a non-mobile user interface 126 may provide users with the ability to communicate with the knowledge manager 136. In one embodiment, all data accessed through the external application portal 122 is located at its original distribution point, such as, for example, a SAN data store or command specific information located locally at the knowledge manager 136 site. The external application portal 122 (or, in some embodiments, the API 114 and/or non-mobile user interface 126) provides for the use of pre-designated profiles and may allow the end-users to customize their profiles to gain access to various portions of the data managed by the knowledge manager 136. Accordingly, users can access data based on their specific needs.

The data replication store (DRS) tier 106 may include a local version of the global components associated with knowledge manager 136. These local components may include a local knowledge manager, local content manager, local search engine, local synchronization service, local configuration manager service, local knowledge manager administrator's workstation, and local user interface. Each of these components associated with the data replication store (DRS) tier 106 is discussed in greater detail, below. Generally, the data replication environment 106 constitutes the set of physical and logical functionality associated with a local data unit 132 or 134. A general collection of all applicable data may be maintained by the data management tier 102. Different local data units in the data maintenance or data replication store (DRS) tier 106 may be populated with different data sets, depending on factors such as the type of deployment associated with the data unit 132, and needs and permissions of the users at the data unit 132. User profiles can be maintained using the functionality associated with the data management component (DMC) tier 104. The transfer of updated documents and data from the data repository (DR) tier 102 and the data replication store (DRS) tier 106 can be mediated by the functionality of the data management component (DMC) 104 and the knowledge manager 136. That is, synchronizations can be performed for individual data units using information controlled by the administrator(s) of the data management component (DMC) tier. In this manner, specific data units need only obtain synchronized data relating to that specific unit. In addition, the data replication store (DRS) tier 106 can use the local knowledge manager and search engine functionality to perform searches and obtain data relating to other applications and other units (provided user profiles allow for such searches and data accesses). Manipulation of user profiles or of profiles of specific data units can be performed using the tools associated with the knowledge manager.

In the illustration of FIG. 1, the data replication store (DRS) tier 106 can operate in either a connected mode 128 or a disconnected mode 130. These modes are explained in greater detail below. In general, when the local data unit 132 is in connected mode 128, the local knowledge manager component of the local data unit 132 is connected to the global network (and hence the data repository (DR) environment 102). During this period, the local data unit 132 may be in an active state of synchronization with the data store 138, and users at the local data unit 132 can perform searches or obtain the most updated documents in near real time. In disconnected mode 130, a local data unit effectively functions as a stand-alone unit 134. In this mode, all data comes from the data unit itself (rather than from the master repository, i.e., the data store 138), which data is current as of the last synchronization session with the knowledge manager 136 or through updates obtained using other media.

Document systems including the system of the present invention may also be used in peer to peer configurations, as opposed to the more traditional client-server environments. In peer to peer configurations, each data site or node may include its own functionality for enabling the management, transmission and reception of documents between other nodes. Distributed configurations involve a similar segmentation of software components.

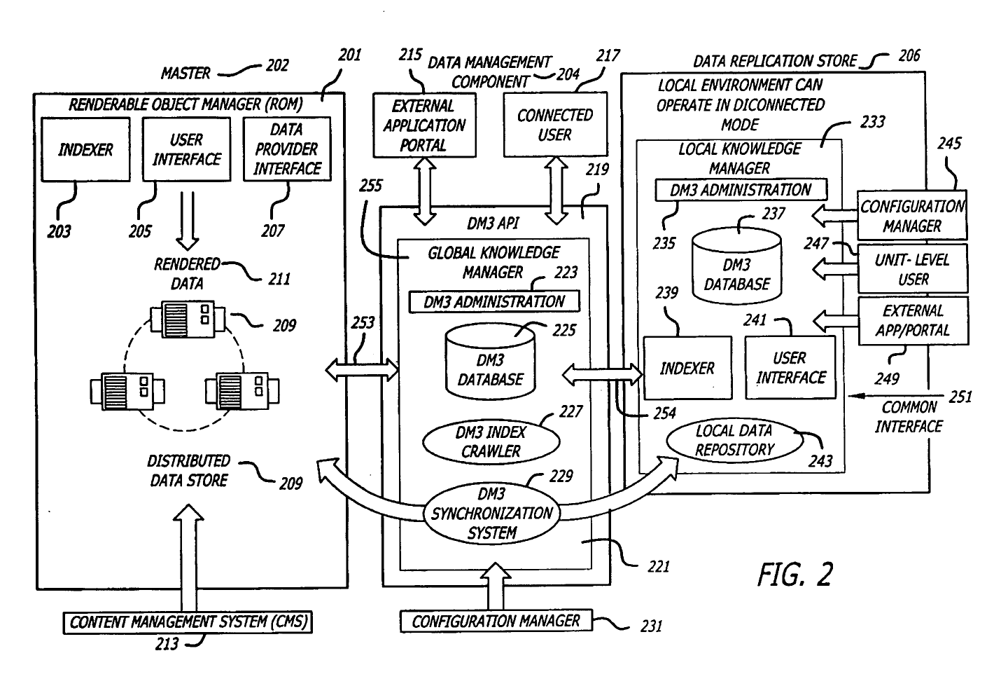

FIG. 2 is an illustration of a multi-tier document management system in accordance with another embodiment of the present invention. The master repository (corresponding to data repository (DR) tier) 202 is shown, along with the data management component (DMC) tier 204 and data replication store (DRS) tier 206. The master repository includes a content management system 213 which may include a number of subsystem components for facilitating the storage, addition, removal, and updating of data stored in the master repository 202. For example, a renderable object manager (ROM) 201 may include an indexer 203, user interface 205, and data provider interface 207. The ROM 201 may generally include a multi-layer software solution for controlling the flow of data into the master repository 202. An indexer 203 may be used to identify the current location and revision of data stored in the master repository 202. In other configurations, indexer 203 may be used to keep track of the revision history of documents, or to categorize documents according to certain criteria applicable to a customer. A user interface 205 may provide an administrator or other individual with access to the master repository 202 for maintenance and administration purposes, or to perform searches, etc. A data provider interface 207 may provide a vehicle for a customer or other entity to input data into the master repository, either automatically through a series of executable routines, or manually. Data input into the master repository 202 results in rendered data 211 that generally is placed into an array of physical memory devices such as the distributed data store 209. In general, while the master repository 202 may be considered as a single logical entity, the distributed data store 209 may be segmented into multiple physical structures such as SANs or RAID arrays, etc.

Mediating between the master 202 and data replication store (DRS) 206 is the data management component (DMC) 204, in this illustration through logical link 253 from the master 202 to the global knowledge manager 255. As indicated previously, the global knowledge manager 255 generally installs at a base location (typically in proximity to or at the same location as the master 202) and is administrated by a central “command” as governed by the structure, attributes and requirements of the customer entity. As is shown in this illustration, the capabilities of the global knowledge manager 255 may be exploited via the DM3 application programming interface (API) which provides a uniform interface structure and a set of commands for performing various functions and services within the global knowledge manager.

The data management component (DMC) tier 204 includes a configuration manager 231, which is a collection of software routines responsible for identifying within the master repository 202 a specific collection of data that is applicable to a given data unit within the data replication store (DRS) 206. As noted, the configuration manager 231 typically accomplishes this identification procedure by maintaining a mapping between data sets and different end users. DM3 administration component 223 may include a series of routines for administrating the data management component (DMC) and for making amendments to user profiles, permissions, authentication procedures, the applicability of data sets, etc. Information pertaining to data management component (DMC) administration may be stored in DM3 database 225, accessible to an administrator via the global knowledge manager 255 and a user interface 215 or 217, or DM3 API 219.

DM3 index crawler 227 may be used to identify the current location and revision of data managed by the global knowledge manager 255 or local knowledge manager 233. Access to the index crawler functionality 227 by the local knowledge manager entity in the data replication store (DRS) tier 206 may be accomplished via logical link 254 and DM3 API 219. The two logical links 253 and 254 may be any known network connection, or in some instances (such as where the data management component (DMC) 204 functionality resides at the master 202) a network connection may not be required. DM3 synchronization service 229 also resides within data management component (DMC) tier 204 and may be used to synchronize data between the distributed data store 209 of master tier 202 and a local data repository 243 associated with data replication store (DRS) tier 206, in a manner described in this disclosure.

User access to the functionality of the data management component (DMC) tier 204 may also be accomplished through a direct user interface in which a connected user 217 has access, or through an external application portal 215 for use by third party applications, such as applications specific to the customer.

A data replication store (DRS) tier 206 is also shown in FIG. 2 which discloses a local knowledge manager 233. In this configuration, the local knowledge manager 233 resides at the unit location and permits, among other functions, local modification by a user of the information in local data repository 243. As in this illustration, the global knowledge manager 255 remains the “parent node” even though the local knowledge manager 233 can operate independently, such as in situations when it is disconnected from the global knowledge manager 255.

The local knowledge manager 233 in this embodiment includes capabilities that essentially mirror the capabilities of the global knowledge manager 255. Similar components include: a DM3 administration component 235 used for a system administrator of the local unit; a DM3 database for storing data used by the local knowledge manager 233 such as data pertaining to authentication, user profiles, etc.; an indexer 239 for indexing the data or keeping track of revision histories in local data repository 243; a user interface 241 for allowing a user at the local unit access to the data in the local data repository (as limited by the applicable permissions and profile of the user); and a configuration manager 245 for identifying data sets applicable to specific users (for example, when in disconnected mode). In the illustration shown, a unit-level user 247 is accessing the local data repository 243 using the local knowledge manager 233 and user interface 241. Further included is a portal for external applications, which provides an interface for a user's third party applications designed to operate in conjunction with the local data repository 243 and local knowledge manager 233. A common interface 251 may provide an API containing a series of commands or procedures of the local knowledge manager 233 that are accessible to the user.

Below, the three tiers of various embodiments of the document management system are set forth in greater detail.

Logical Master (Data Repository (DR)) Repository—Data Management

In one embodiment, a logical master repository stores all documents and revisions. The master repository maintains sets and families of documents, keeping track of the revision history of documents. The master repository in one implementation is a single logical entity; however, the repository can consist of multiple physical entities. By way of example, a RAID-based array of disks can be spread across a number of computers for storing the data. In addition, one of the various networks of physical data storage techniques can be used to implement the master repository. In other embodiments, the data from the master repository is located in a single physical entity.

In certain circumstances, the master repository may also serve as a “remote” database for an end user to search and view. An appropriate search engine may be employed for the end user to conduct searches and identify the latest document revisions.

The master repository includes a data store, which may constitute the primary repository for all data and control information necessary to populate the end-user digital libraries. The specific hardware requirements of the data store (e.g., a storage area network, simple RAID array, etc.) are dependent on the applications and needs of end users. Again, however, the data store is typically redundant in nature and able to sustain single hardware component failures without data loss or significant downtime.

The master repository in certain implementations also includes a content manager. The content manager controls all access to the data store. In one embodiment, the content manager includes a web service with a published interface language (e.g., WSDL) that can be used by end users for interfacing. A customizable client may also be provided to the end users for controlling the content manager.

Communication with the content manager may occur locally, or over a network such as a TCP/IP network using HTTP or HTTPS protocols with different levels of authentication ranging from a simple “user ID/password” mechanism to server/client authentication using digital certificates, the latter vehicle typically being employed for particularly sensitive applications.

The content manager may provide, in various embodiments, one or more of the following capabilities:
(1) List all documents located in the data store or repositories thereof;
(2) Search for documents and/or retrieve documents in the data store based on some match criteria input by a user or program;
(3) Add new or revised documents to the data store; or
(4) Remove documents or versions from the data store based on some match or other criteria from an end user or application.

In one embodiment, an exemplary WSDL interface may be tailored to provide a suitable web interface to these capabilities. WSDL is an XML format language for describing network services as a set of endpoints operating on messages containing either document-oriented or procedure-oriented information. The operations and messages using WSDL are generally described abstractly, and then bound to a concrete network protocol and message format to define an endpoint. Related concrete endpoints may be combined into abstract endpoints, often referred to as services. While other languages can be used, WSDL is extensible to allow description of endpoints and their messages regardless of what message formats or network protocols are used to communicate. For example, WSDL may be used in conjunction with (among other protocols) SOAP 1.1, HTTP GET/POST, and MIME.

The logical master repository may also include one or more search engines for enabling searches by keywords, title, document identifying attributes, revision, author, and other metadata. In one embodiment, the search engine is highly customizable and can easily be adapted to search against customer defined data. A single term or a phrase may be used for search purposes. In other embodiments, multiple terms may be combined together with Boolean operators to form a more complex query or query set. The search engine in some configurations supports single and multiple character wildcard searches. In addition, the search engine may support fuzzy searches based on the Levenshtein Distance or Edit Distance algorithms. The search engine may also allow range queries and proximity searches. The searches can also be grouped.

The logical master repository also includes a synchronization mechanism which, in one embodiment, interfaces with a synchronization mechanism in the data management component (DMC) to provide for the synchronization of data between a user site and the logical master repository.

In many embodiments, data transfers between the data repository (DR) and external entities attempt to take advantage of existing data sets and versioning information. This technique may allow for very efficient bandwidth utilization and much faster updates. Updates to the data store of the master repository over a network transfer, in one embodiment, include only the changed bytes of data instead of complete data sets when loading data from a user site.

In addition, the logical master repository according to some configuration may include a mechanism for redundancy to protect faults like system crashes or defective hardware. Conventional storage arrays and networks may be used for this purpose. While in one embodiment the logical master repository includes a single logical instance, the master repository is scalable and can also consist of multiple physical redundant systems for failover and load balancing purposes.

Knowledge Data Management Component (DMC)—Data Movement

In one aspect of the present invention, a knowledge data management component (DMC) is employed as described above. The knowledge data management component (DMC) may be a logical entity which is comprised of several individual services that function together to create an overall knowledge management function. In one embodiment, these functions are considered separate entities; however they generally should be capable of communicating with one another in order to provide an end user with an integrated data system with multiple capabilities. The knowledge data management component (DMC) may include: an overall knowledge manager that identifies the user and knows where the applicable data that the particular user needs is located; a user interface web page that facilitates the communication of the appropriate information to and from the knowledge data management component (DMC); an index crawler service that may identify the current location and revision of the data managed by the knowledge data management component (DMC); a configuration manager that provides the knowledge data management component (DMC) with the ability to identify which data is applicable to a specific user; and a synchronization service that maintains the local data sets with the most current data available.

An overall knowledge manager in some embodiments has two major implementations working in conjunction with each other. A Global Knowledge Manager (GKM) may be installed at a base or central location and is administrated by a base command (such as in the case of a military application). A Local Knowledge Manager (LKM) may be at the end user location. In some instances, the LKM permits local modification of the digital library by the end user. The GKM and LKM may work in conjunction with one another, as described above, to provide an integrated set of data management and movement capabilities to the central location and an end user's location. The GKM may be the parent node for the knowledge manager and each LKM installation may constitute a child node that, depending on the application, may be able to operate independently (disconnected) from the parent node. Even in this latter situation, the child node still relies on the parent node to determine criteria including the latest data available for the node.

A knowledge manager administration user interface may enable remote administration of the configuration manager and streamlined maintenance of user profiles.

A synchronization service within the knowledge data management component (DMC) may perform data synchronization between the GKM and the LKM, and between either the GKM or LKM and the logical master repository. The synchronization service may identify the LKM by attributes contained within its profile. Based on the profile, the synchronization service may identify the applicable documents, renderable objects (ROs) and database records necessary to make a complete digital library for the specific LKM. The synchronization service may identify the applicable library by communicating with the configuration manager and GKM, and then doing a comparison of the identified library with the current data set under control by the LKM. The synchronization service then locates and transfers all necessary documents, ROs, knowledge manager database records and configuration manager database records to the LKM performing the applicable add, modify or delete actions necessary to consummate the process and completely synchronize the LKM's data library with the applicable library identified by the GKM.

In one embodiment, only the data applicable to the identified profiles will be synchronized. Additionally, only the modified data transfers between the FKM and the LKM, i.e., the incremental update technology or byte level synchronization, is employed. If the GKM's identified data already matches the LKM's data, the synchronization service need not transfer the data. The synchronization service also reports all actions to both the GKM and LKM administrators, so that each entity is kept updated with respect to synchronization actions that may have been performed.

In some implementations, the synchronization service is capable of operating in a continuous mode with synchronization actions being performed on a predefined schedule based on systems settings controlled by either the LKM or GKM administrators. The settings established by the GKM ordinarily take precedence over the LKM. While in continuous mode, the synchronization service may monitor all data applicable to a particular user profile and, with the help of an index crawler or other application, the synchronization service may identify and synchronize any data required to be added, modified, or deleted at the predefined data stores (e.g., located at a user site). Once data is updated at one of the data stores pursuant to this process, the synchronization service may automatically synchronize the LKM's data library.

In other configurations, the synchronization service is also capable of operating in both a “push” and “pull” mode, meaning that data can be transferred in either direction (towards the master repository or towards an end user site). The mode in one embodiment is determined by the users, rather than the technology or application. Either the LKM or GKM administrator has the ability to initiate the manual execution of the synchronization service.

A local synchronization service may also be present for operating in standalone mode. This mode may occur, for example, when the unit constituting a user site is not connected via a network or otherwise to the logical master repository, but still may receive data through some form of transportable media (e.g., CD-ROM, DVD, etc.) from an outside organization through one of the official distribution channels. An illustrative scenario involving the use of this service may be where an end user site is located on a ship or aircraft, and a long deployment occurs wherein the unit is unable to connect to the GKM and perform an online synchronization procedure. While in this manual mode, the local administrator may place the newly provided data from the transportable medium onto a predefined location of a local network to which the end user's repository is coupled. Thereupon, the local synchronization service, with the possible assistance from a local index crawler, local configuration manager or other application(s), can identify the necessary undated or new data on the medium and synchronize the new data with the existing local data set.

The data management component (DMC) may also include a configuration manager. The configuration manager constitutes the entity responsible for identifying the data applicable to a specific end user. The configuration manager in one embodiment maintains a hashed mapping between data sets and end users. It provides an external interface to manage different user configurations based on different input criteria. The input criteria is customizable to the specific needs of end users, and is limited by their applicable permissions as defined in their respective user profiles.

As an illustration, in a sensitive military application, the configuration manager may employ a web-based messaging system which is capable of identifying and returning data describing the technical documentation to an applicable individual class of ships or aircrafts to an external application. The technical documentation may also relate to multiple classes of ships or aircrafts, an individual ship or aircraft, or multiple ships or aircrafts. The identified data may contain the appropriate revisions/changes, if any, applicable to the requested unit. The configuration manager is capable of returning data sets that include large amounts of configuration data such as technical manuals, checklists and drawings applicable to a specific device, aircraft, ship, etc. The configuration manager may return the change or revision of a specific technical manual, checklist, drawing, etc., based on the technical document number and its applicable unit.

In one embodiment, the configuration manager includes a web service that typically runs “behind the scenes”. The configuration manager is coupled to a database through intermediary layers of software, and provides a user interface to an end user for manipulating and moving data and other functions as described herein.

In another aspect, a suitable application programming interface (API) or web-services interfaces provides a common interface structure so that other programs can seamlessly access the functionality of the knowledge manager. The API interface may be made available for the ease of use of third party applications and will describe the methods and attributes of the knowledge manager.

In addition, in some embodiments, a web portal-type interface (“data management component (DMC) user interface”) may provide users with the ability to communicate with the GKM. Data accessed through the data management component (DMC) user interface is generally located at its original distribution point, such as the Army's Joint Computer-Assisted Logistics System (JCALS) SAN data store or command specific information located locally at the GKM's site. The data management component (DMC) user interface permits the use of predefined profiles or permits end-users in certain circumstances to customize their profiles to gain access to all or a portion of the data managed by the data management component (DMC). This capability allows users access to filtered or unfiltered data based on specific needs and limited, if applicable, by governing permissions, the latter which may be overseen by another entity.

An illustration in a navy environment relates to a shipyard worker who is primarily interested in data related to a specific type of submarine. Initially, the user may select a predefined profile for that submarine. However, the next day the shipyard worker may need information directed to high-pressure air compressors. In that case, the worker may need to search the entire knowledge store at the master repository for this information. The data management component (DMC) user interface allows an unfiltered search for the data to find the largest data set available. Additionally, the shipyard worker may want to create a custom profile to narrow the amount of data to a specific area of interest but still provide access to a larger portion of the data store when compared to a predefined profile.

In another embodiment, the data management component (DMC) layer allows for the caching of data that commonly may be read to or written from local libraries. Thus, data that is most commonly transferred may reside in a repository controlled by the data management component (DMC) software layer and accessible by a user site. This caching capability enables the data management component (DMC) to establish a connection with a user site and provide information much more quickly than where the information is located in the master repository. This caching mechanism can also be used for data transferred in the other direction—namely, from user sites to the master repository.

Local (Data Replication Store (DRS)) Environment—Data Maintenance

The local or data replication store (DRS) environment manages one or more repositories for maintaining data locally at designated user sites. In one embodiment, the data replication store (DRS) also provides a web-based user interface to control various actions. Typically, a single data replication store (DRS) handles multiple end users. Each user is differentiated based on a user profile which is used to control the user's access to documents.

In some embodiments, the local environment is operable in two modes. A connected mode is used when the LKM component of the digital library is connected to the global network—such as, in the illustration using the navy, when the ship is in port—and in communication with the GKM. During the connected period, the local digital library (that is, the information residing in the user data unit) is in a state of synchronization between the LKM and GKM. Local users still can access the required data from the local data store, rather than the logical master repository. In one embodiment, it is the responsibility of the synchronization service (whether automatic or manual) to ensure that local users have the ability to view the most up to date data available. Additionally, in the connected mode, local users with appropriate permissions will be able to access information directly through the GKM interface to the supplier network, including the master repository. This latter situation may arise when a local user needs to view data not directly applicable to his or her local site. For example, if the local site resides on a military aircraft, and the local user is part of a unit that needs access to information regarding another aircraft or an issue not directly pertinent to the aircraft, the user may access the master repository for this information.

The disconnected mode usually occurs when the local user site or unit does not have the means to communicate with the GKM. The example described above is when a local site resides in a seacraft which is not in port and not connected to the GKM using the required networking mechanism. While in disconnected mode, all data generally comes from the local data store. This data is current as of the last synchronization session with the GKM or via other updates (such as CD-ROM, etc.)

In some implementations, the LKM component is a mobile piece of software that installs at the unit level. The LKM may deploy with the unit and can function separately from the total system (such as, for example, in disconnected mode). In general, the functionality available to the data management component (DMC) environment (GKM) replicates at the data replication store (DRS) environment (LKM) because the data replication store (DRS) environment may have the capability to operate in disconnected mode.

A local content manager may be used in still other embodiments. The content manager may control all access to the local data store. The content manager transparently connects to the data repository (DR) document store (master repository) as necessary in connected mode. In embodiments using internet-based protocols, access may be permitted through the local user interface using HTTP or HTTPS protocols with different levels of authentication ranging from simple user-ID/password control to server and client authentication using digital certificates.

The local content manager may provide some or all of the following capabilities:
(1) List all documents in the document store;
(2) Search for documents in the document store based on some match criteria;
(3) Retrieve documents from the document store based on some match criteria;
(4) Add new or updated documents to the document store;
(5) Remove documents from the document store based on some match criteria.

The data store can be updated through data management component (DMC) synchronization requests and/or through local or remote client utilities. In addition, new documents added to the local store can be “reverse-synchronized” to the master repository by the GKM administrator.

The data replication store (DRS) environment may also include a local search engine. The local search engine enables searches by keywords, title, document ID, revision, author, and any defined metadata. The search engine is highly customizable and can be easily adapted to search against customer or user defined data. A single term or a phrase can be used, for example, for search purposes. Multiple terms can be combined together with Boolean operators to form a more complex query. The search engine may support single and multiple character wildcard searches. The search engine may also support fuzzy searches based on various algorithms, and may allow range queries and proximity searches. The searches can also be grouped.

A local synchronization service may also be utilized within the data replication store (DRS) environment. The service is utilized when the unit is not connected to the base but still receives data from an outside organization through one of the official or recognized distribution channels. One possible illustration involving the use of the local synchronization service is a long deployment when the unit is unable to connect to the data management component (DMC) and perform online synchronization. While in manual mode, the local administrator may place the newly provided data (from any media such as CD-ROM, DVD, magnetic tape, etc.) into a predefined or designated location on the local network used by the data replication store (DRS). The local synchronization service (in some instances with the help of the local configuration manager described below) may identify the necessary data in the update and synchronize the new data with the existing local data set.

In addition, a local configuration manager service may be used in the data replication store (DRS) environment to identify which data is applicable to a specific command, unit, or user. In some implementations, this service constitutes a back-up component that enables disaster recovery in the disconnected mode. Prior to disconnecting, the data replication store (DRS) unit should have all information associated with the deploying equipment via the data management component (DMC). However, the local configuration manager may enable the local administrator to configure the system for disaster recovery.

In one embodiment, a local component of the LKM administrator's workstation function is made available to the manager of a data replication store (DRS) site to accommodate functions associated with remote administration. Some or all of the following administration functions may be included:
(1) Global synchronization setup (connected mode)
(2) Local synchronization setup (disconnected mode)
(3) Local configuration manager setup
(4) Local data store updates
(5) User profile maintenance

A local user interface may also be provided. For example, a web page may be used to provide local users with the ability to communicate with the LKM. In some implementations, all data accessed through the local user interface will be located on the network. In other implementations, the local user interface may also allow users to access information related to other pieces of equipment, ships, or units while in connected mode.

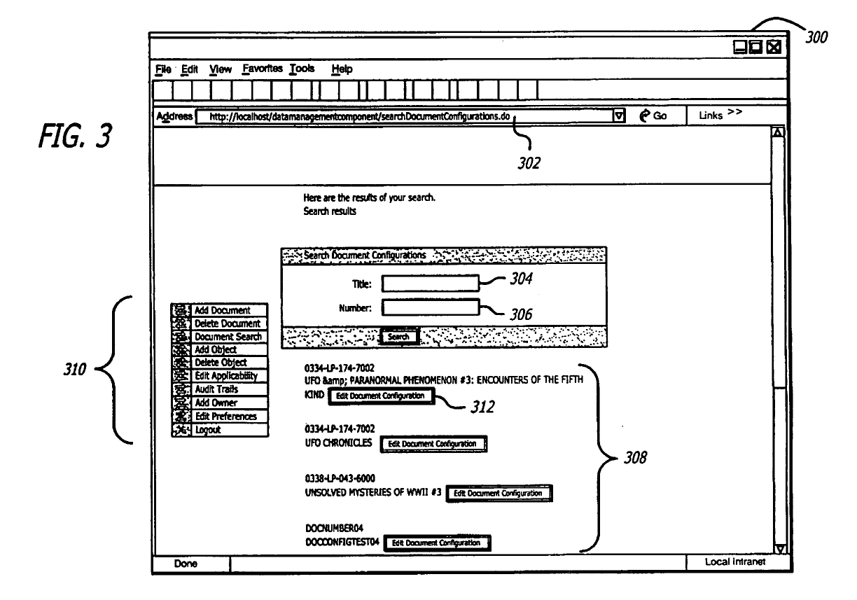

FIG. 3 shows an example of a user search engine web interface page 300 in accordance with an embodiment of the present invention. The user interface 300 is in a web-based, user friendly format, and provides a vehicle for access to the capabilities of a local knowledge manager at a local data unit. A user may navigate to a particular page using conventional web-based techniques, as shown by uniform resource locator 302. In this example http is used, although https may be used in more sensitive applications. In still other applications, such as applications where greater security is provided, another type of user interface may be more appropriate. Accordingly, different types of user interfaces may be used without departing from the spirit or scope of the present invention.

The search engine in FIG. 3 allows a user at a remote site to enter a document title (box 304) or document number (box 306) to access a document, or body of documents of interest. A list of results 308 may appear in which the identity of the document at issue as well as other possible options (including an edit document configuration option 312) may be available. In addition, the user interface 300 includes a collection of links 310 which may encompass a drop down menu for adding and deleting various documents or objects, for editing user preferences, or for performing various administrative functions.

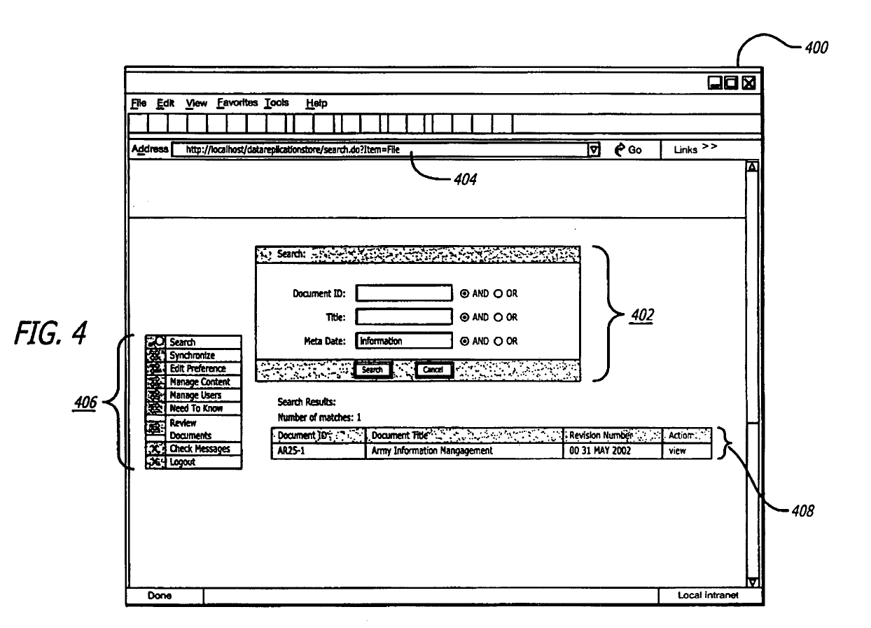

FIG. 4 is another example of a web-based user interface 400 in accordance with an embodiment of the present invention. The interface 400 may be suitable for a system administrator, as illustrated by the links 406. An administrator can manage the accessibility of various content to specific users, or can designate certain documents “need to know”, etc. The interface 400 also provides a search engine 402 which enables searches based on Document ID, Title, and Meta Data, all including Boolean operator functionality. In this example, the results of a search are displayed in a template 408 beneath the search input template 402.

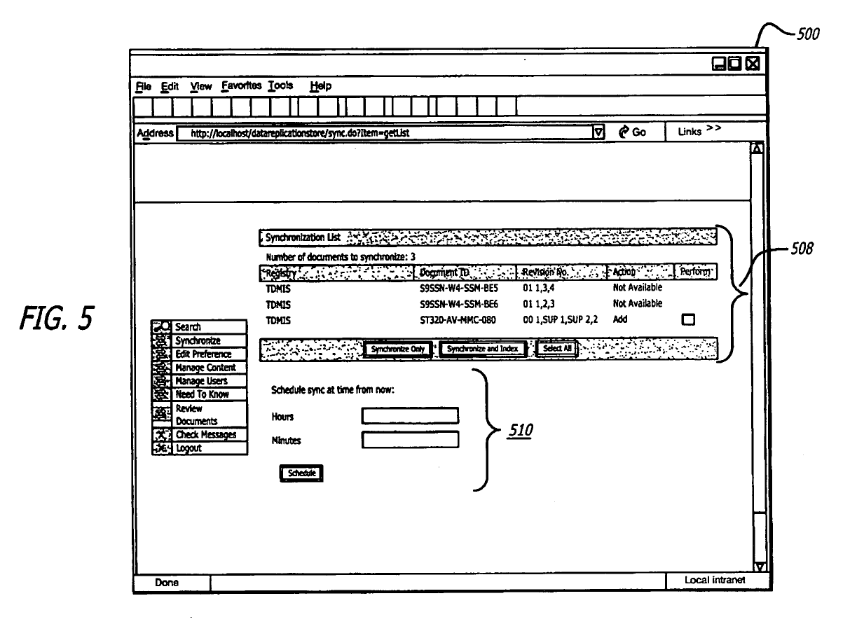

FIG. 5 is an example of a user interface 500 for facilitating the manual synchronization of documents in accordance with an embodiment of the present invention. As noted above, synchronization can occur both automatically or in a manual mode depending on the configuration. In this example, a synchronization template is provided which lists the specific documents which a user wishes to synchronize with the master repository. The user has the option to synchronize one or more of the documents, or to synchronize and index the documents as shown in template 508. Template 510 provides for an additional option to schedule the synchronization of the data to a certain time.

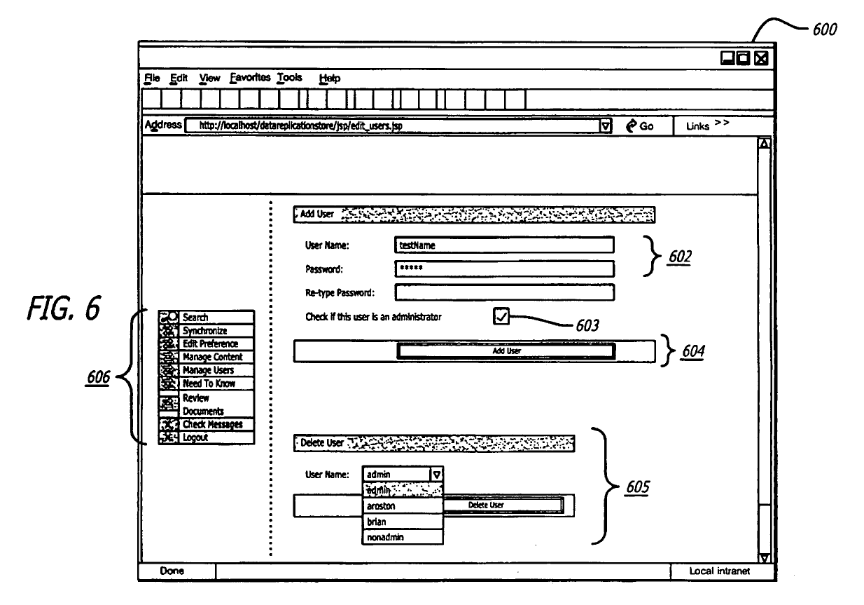

FIG. 6 is an example of a web-based user interface 600 that provides a login screen in accordance with an embodiment of the present invention. A template 602 provides a standard mechanism for a user to log onto the system. As shown in 603, the system can determine whether the user is an administrator, in which case certain additional privileges may be accorded that individual. For example, where the user is an administrator, the user may be able to add additional users as in 604, to delete users as in 605, or to manage or change the various permissions of users as described in the various options associated with links 606.

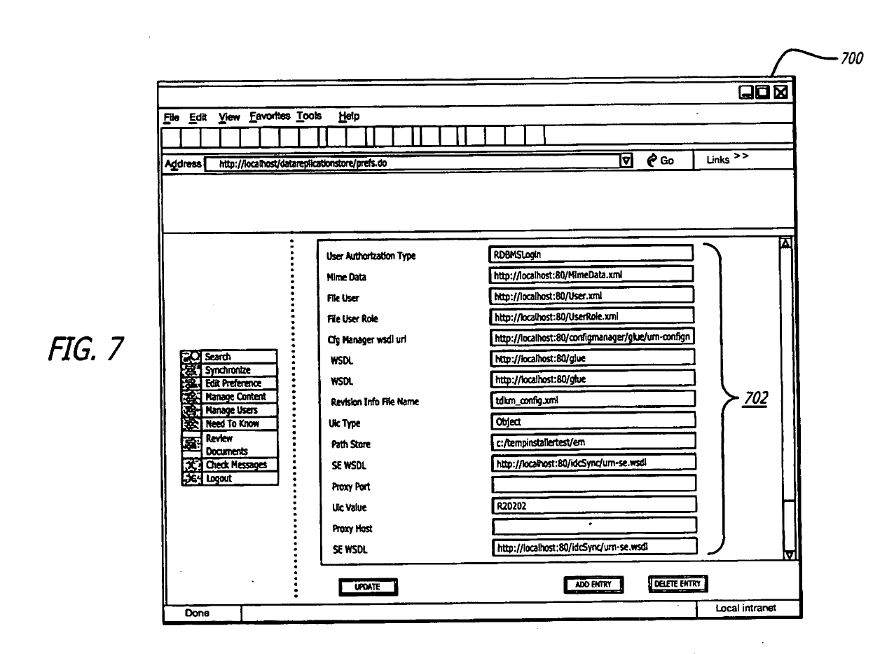

FIG. 7 is an example of a web-based user interface 700 for providing information regarding various aspects of the system. Template 702, for example, provides a user with information relating to various roles of the data management component (DMC) and data replication store (DRS) as well as their respective URLs. Additional details relating to the configuration of the system (such as the WSDL and port locations) are provided. Using the web-based interface, a user at a local unit can have broad and seamless access to cross-navigational links which can provide an efficient way to obtain necessary information quickly. It will be appreciated that these user interfaces are illustrative in nature, and that significant modifications or departures from these examples can be made without departing from the scope of the present invention.

The GKM may operate as a primary user interface portal for integration of other systems. The GKM may also “snap in” to existing systems and rely on those system's user management functions, such as profiles, to filter the information to a specific topic or user. The portal may provide a web-based interface that presents information in a format to which users are already accustomed and allow users at all levels to simultaneously access the system using a standard web browser or other interface.

A MIME mapping may be used to map document types to native document viewers. The appropriate native viewer may then be launched whenever viewing a document. The user interface may allow for customization based on user needs.

In another aspect of the present invention, a method and system for smart synchronization is provided. The method and system selects, at the time the synchronization procedure is commenced, one or more synchronization algorithms specific to the data types to be synchronized over a network. A synchronization algorithm may include, for example, a suitable compression and reduction algorithm, and in some instances other routines for manipulating the metadata of a file. As a result of this “smart” selection of appropriate synchronization algorithms employed at run time (i.e., commencement of the synchronization procedure upon command of a user, computer program, or otherwise), the transmission of the files over the network may be consummated to maximize efficiency and minimize bandwidth. As a result, network resources and cost savings may be maximized by the user of the underlying data/document management system.

Synchronization methods according to the present invention may take into consideration, in some embodiments, dipping size, data size, and the types of changes or updates to the data to be synchronized. In some instances, a simple algorithm may be optimal. Other types of data, such as video data necessitating particular compression techniques, may require more elaborate synchronization algorithms to effect a comparatively low bandwidth transmission over a network. In one embodiment, the data to be synchronized at run time is analyzed at a granular level to determine what changes were recently made by a user or program, and a determination is made by the software as to the best synchronization technique to execute based on the nature and extent of the changes, the file type, etc. Depending on these factors, one or more specific synchronization routines may be applied and executed at run time which are designed to optimize efficiency of the transfer over the network.

The location of the processor or system that performs the synchronization routines generally depends on the type of data management system. In a simpler, two-tier system containing a master data repository and a plurality of local data units, the master data repository may be controlled by one or more central server computers coupled, in one implementation, to a configuration of hard disk drives organized in a RAID array. One or more of these server computers typically contains a processor that executes the necessary routines to effect the transmission of data over the network. The routines may be implemented alternatively on multiple processors, dedicated hardware, network interface cards, or the like. The processor may be a dedicated processor, such as a digital signal processor (DSP), and need not be a general purpose processor.

At the local end, a computer may be coupled to a local data unit which either executes or receives synchronization commands. In the case where the computer at the local data unit receives the synchronization commands, the computer at the local data unit may transmit an acknowledgement. Various handshaking algorithms may be performed between the two nodes immediately prior to or during synchronization, at which point the appropriate updated files are transmitted over the network. The computer at the local data unit may contain a general purpose processor, along with standard computer components (RAM memory, network interface card, etc.) and a local hard drive for storing the synchronized data. Alternatively, a local data unit may be a thin client or dumb terminal, with some type of storage capability for receiving and storing data specific to the data management system in place.

The synchronization system and method as described herein may include more elaborate systems, such as the document management system disclosed in this specification. This system may include a master data repository, a plurality of data replication components, each including one or more data storage areas, and a data management component for managing the movement of data between the master data repository and the and the data replication components.

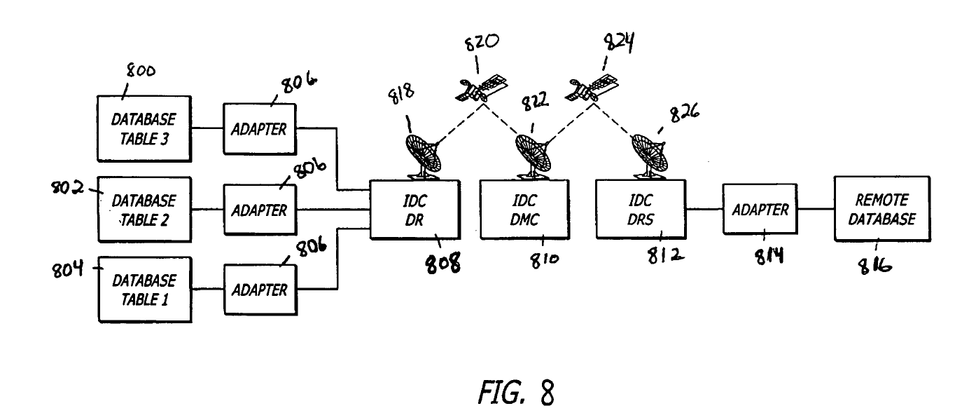

FIG. 8 is a block diagram of a system for performing smart synchronization in accordance with an embodiment of the invention. The components in FIG. 8 include an IDC Data Repository (DR) 808 coupled via the three adapters 806 to database table 1 (804), table 2 (802), and table 3 (800). In one implementation, the three adapters 806 are software adapters used to interface between the various databases and the IDC DR 808. The adapters 806 may be used to connect existing data repositories to execute and perform any necessary translations between the data as stored in tables 800, 802 and 804 and the data controlled by the IDC DRS component 812. In the embodiment shown, the IDC DR 808 transmits and receives data wirelessly via a satellite dish 818 and satellite 820, which in turn transmits and receives data to and from the IDC Data Management Component (DMC) 810 via satellite dish 822. The IDC DMC 810 may communicate with the IDC Data Replication Store (DRS) 812 in a similar manner, using satellite dishes 822 and 826 and satellite 824. Other methods of connection, including one or more hardwired networks, may be suitable in other configurations. The IDC DRS 812 is then coupled to a remote database 816 via software adapter 814.

The system disclosed in FIG. 8 may use a bi-directional synchronization system. In one embodiment, the IDC DRS 812 is a software component that resides on a machine and is coupled to a remote database (which may, but need not, reside on the same machine as the IDC DRS 812) as noted above. A function of the IDC DRS 812 in one embodiment is to synchronize data across low bandwidth networks.

In one embodiment, a user accessing remote database 816 wishes to acquire from the IDC DR 808 the most up-to-date data applicable to the user's profile. The user may, depending on the configuration, access remote database 816 through the web browser or other interface of a PC or workstation, or through a third party interface associated with an embedded or mobile device. The IDC DRS 812 receives this request via adapter 814, and issues a request back to the IDC DMC 810 that the computer controlling the remote database has requested a synchronization. In some embodiments, the IDC DRS 812 also submits data which includes a summary of what data presently exists in the remote database 816. The IDC DMC 810 may contain information about the configuration, profiles, and other attributes of the data resident at tables 800, 802 and 804, and can compare that data with the data in the remote database 816 to establish whether one or more updates are needed. Thereupon, after verifying the applicable permissions and the necessity for a data transfer, the IDC DMC 810 issues a request to the IDC DR 808 to perform a data synchronization. In one embodiment, the IDC DR 808 takes the summary data and compares it to data in any of its databases to verify that it has new data to transfer to the remote database 816.

The IDC DR 808 may then execute a data transfer. According to one embodiment, the smart synchronization software analyzes the data to be transferred and determines the most optimal and efficient manner to move it over the network(s) for arrival at remote database 816. In particular, the IDC DR 808 in one embodiment contains DM3 software that selects the best synchronization algorithm to use based on the type(s) of data to be sent, and in some cases, based on the bandwidth available on the particular network in use. One objective of the smart synchronization technique is to minimize, by recognizing file types and attributes, the actual amount of data that needs to be transferred. As such, the smart synchronization software governs how the data is replicated from the databases 800, 802 and 804 to the remote database 816.

In another aspect of the present invention, a selective synchronization method and apparatus is employed wherein the user (or the DMC, etc.) may configure the synchronization process to transfer only changes in data rather than synchronizing entire data sets. In this manner, only the changes or updates in various files may be transferred to the remote database 816, as opposed to entire files, much or most of which may already be identical to the files stored on the remote database 816. The use of selective synchronization may save considerable bandwidth by avoiding the needless transfer of files that are already current at remote sites.

In some embodiments, the IDC DR 808 transfers the replicated data securely to the IDC DMC 810. At the IDC DMC 810, the data may be filtered, compressed and distributed according to the applicable synchronization algorithm(s).

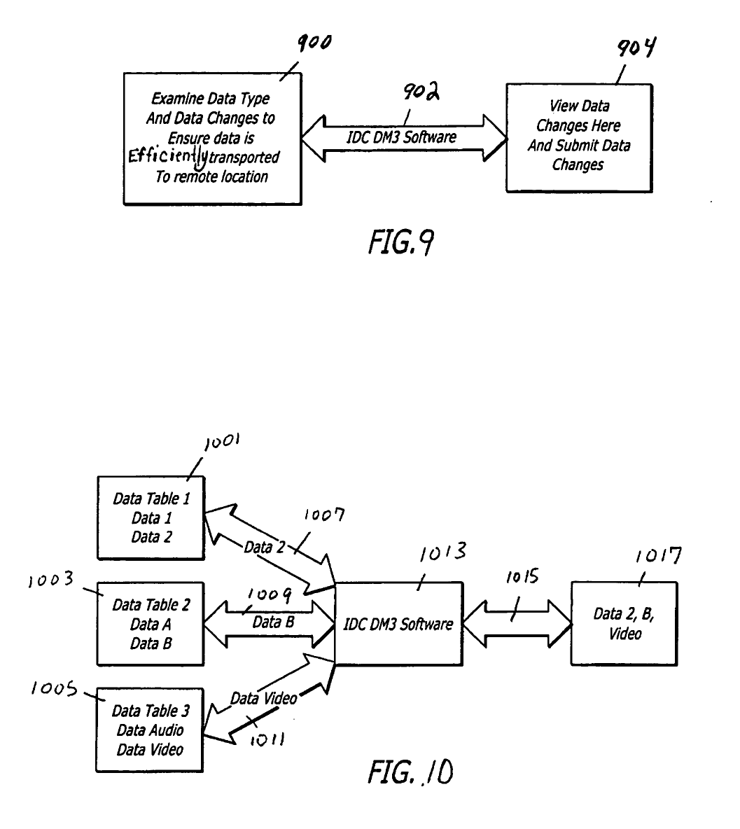

FIG. 9 is a conceptual illustration of the smart synchronization method in accordance with an embodiment of the present invention. Arrow 902 represents the IDC DM3 software used to perform the smart synchronization technique. The arrow 902 is used to conceptually represent the movement of data over a network. Box 900 illustrates a step where, prior to synchronization, the data type is analyzed and the presence of data changes are verified. These steps ensure that updates are necessary and that data is transferred to the remote location in as efficient a manner as possible. In one embodiment, the IDC DM3 software executes this step and governs the efficient transfer of data over the network. Box 904 illustrates a step where the received data is viewed and the changes/updates are submitted to the remote library.

FIG. 10 is an illustration of the selective synchronization method in accordance with an embodiment of the present invention. Selective synchronization is superior to existing synchronization techniques in that, among other attributes, it permits a user or administrator to configure a document management system to transmit segments or pieces or data, rather than synchronizing entire data sets. More specifically, in many synchronization operations, only a small amount of data has actually changed between a master repository and a local database. In these instances, transmitting the entire data set from the master repository to synchronize the local database would tax the bandwidth of the network unnecessarily, particularly for low bandwidth networks or for leased networks where the quantity of data transmitted is price dependent. Selective synchronization is in contrast to smart synchronization, the latter for analyzing the data types prior to transmission and determining the most efficient algorithms to move the data over the network. Both techniques have the effect of performing synchronization in a manner that, in many cases, minimizes the use of network bandwidth.

In FIG. 10, the IDC DM3 software 1013 may perform the selective synchronization routines. Represented in FIG. 10 are three data sets including: data table 1 (1001) containing data pieces 1 and 2; data table 2 (1003) including data pieces A and B; and data table 3 (1005) including a data audio segment and a data video segment. In this illustration, the IDC DM3 software 1013 may determine, based on a summary of information transmitted from the remote database requesting the synchronization, that only data 2, data B, and the data video pieces have changed. Accordingly, only those segments of data—rather than the entire data sets 1001, 1003, and 1005—are transmitted from the master repository to the remote database. The transmission of these data segments are represented by arrows 1007, 1009, 1011, and 1015. Note that the arrows are bidirectional, meaning that synchronization and related signals can travel in both directions. Using the method disclosed in FIG. 10 obviates the need to transfer entire data sets over an already taxed network that the software analysis showed did not need to be transmitted in the first instance. Substantial bandwidth savings may be achieved.

Using the principles of the present invention, data replicated to remote locations may be effected far more efficiently than in existing solutions. The synchronization process consequently becomes more streamlined. Using smart synchronization techniques as described in this specification, data may be replicated efficiently by, among other things, compressing the data to the smallest size possible prior to transmission over the network so that the transfer takes as little time and network bandwidth as possible. The method of initiating synchronization may vary, depending on the configuration. For example, the data may be replicated automatically, or upon request by a user.

The principles of selective synchronization are premised on the practical realization that data that has already been replicated or synchronized should not be replicated again. Instead, only changes to the data should be replicated to ensure that the smallest amount of data is transported across the network. Depending on the embodiment, smart synchronization may be used with or without selective synchronization, and vice versa. In addition, synchronization may, but need not be, bidirectional, and typical document and database management systems implement bidirectional functionality.

The IDC software is configured to move data between machines in a state-of-the-art manner such that, as noted above, the least amount of data is delivered to and from remote locations. Moreover, the IDC software may move existing data regardless of its format, providing not only the capability for smart synchronization, but enabling a long term data solution as data types change or new data types are added. In addition, the IDC software may be configured to use a variety of transport protocols to move data, such as FTP, http, etc.

The IDC DRS (Data Replication Store) can be seamlessly installed on every machine that will send and receive data for replication or synchronization purposes. Once installed, this software component may retrieve data from the existing data repository(ies) and replicate that data to remote locations. As noted above, the DRS may compress the data and use the most appropriate synchronization algorithm depending on the file type(s), so that only the smallest amount of data is transported. In addition, a determination may be made as to what data has already been replicated so that only changes to the data are transmitted, maximizing network efficiency.

The IDC DMC (Data Management Component) functions in some embodiments as an intelligent data router, routing data to be synchronized to the appropriate locations and storing destination addresses of various locations in a table for future use. The DMC is a software component which may allow the user or an administrator to determine where the data on that machine should be transmitted. The DMC may further allow the general data replication/synchronization infrastructure to grow to any size necessary so that data from any machine can be delivered to any other machine pursuant to the principles described herein.

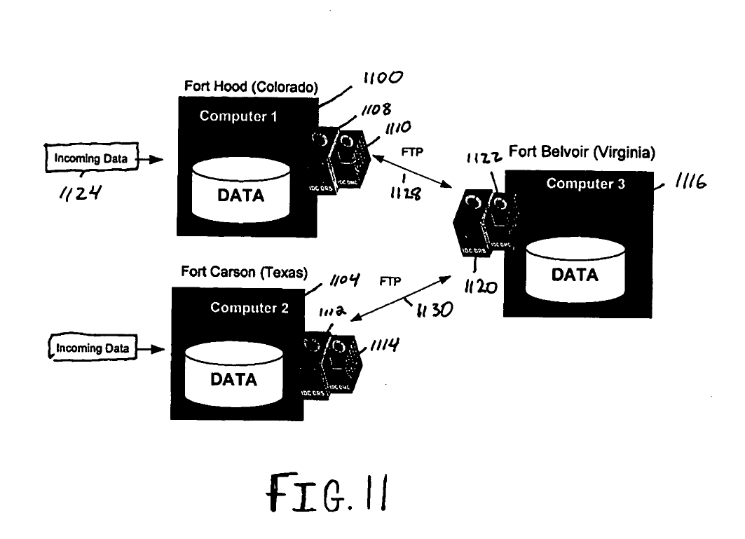

FIG. 11 is a block diagram of a system configured to perform smart synchronization in accordance with an embodiment of the present invention. This example involves a data management system with three exemplary computers distributed in different regions of the country. Computer 1 (1100) resides in Colorado and contains a data repository 1102. The DRS software 1108 and the DMC software components 1110 are placed on computer 1100. Computer 1100 receives incoming data from various sources, as illustrated by block 1124. Similarly, Computer 2 (1104) contains a data repository 1006, and also contains a DRS component 1112 and a DMC component 1114. Computer 2 (1104) is located in Texas for the purposes of this example. Computer 3 (1116) is located in Virginia and contains a database 1118. Computer 3 (1116) also is loaded with software components DRS 1120 and DMC 1122. By placing the IDC DRS and DMC software on the computers in FIG. 11, data can be replicated or synchronized between the locations in Colorado and Texas on one hand to and from the location in Virginia on the other hand. Communications are effected in this example via satellite, using FTP network connections shown by 1128 and 1130.

An illustration of the smart and selective synchronization procedure is now described in the context of FIG. 11. When data resident in database 1106 at Computer 2 (1104) is needed from Computer 3 in Virginia, the following steps may be taken to ensure that the data is replicated as efficiently and reliably is possible. First, the IDC-DRS component 1112 at the Texas location may first make a request for data from Computer 3 (1116) at the Virginia location. First, a determination may be made in connection with this request to ensure that the FTP server at the Virginia location is available. If so, the DRS component 1112 proceeds to issue the request.

Thereupon, the DRS component 1120 at the Virginia location receives the request and determines, using the DMC component 1122, whether its database 1118 contains any data that is applicable or pertinent to the data contained in database 1106 at the Texas location. If so, the DRS component 1120 may analyze its data set for the purpose of determining whether it has received any modifications to the data. If it has received modifications, then in one embodiment Computer 1116 in Virginia will selectively send over only the difference between the data the computer 1104 in Texas already contains and what data the computer 1104 needs. More specifically, only the changes are transmitted.

Moreover, in the illustration above, computer 1116 can employ a smart synchronization technique by examining the file types associated with the changes to be transmitted and be selected a compression/synchronization algorithm that minimizes the transmission of data over the FTP-based satellite network. Using these two methods of smart and selective synchronization, data replication and synchronization systems may be far more efficient than existing solutions. Smart and selective synchronization not only obviates the need for replicating entire data sets to remote locations, but also compresses the data in a manner that minimizes network traffic.

The selection of the order in which data and requests are transmitted and received can vary depending on the specific configuration, and the example in FIG. 11 is for illustrative purposes only. Other protocols, networks, and handshaking mechanisms, etc., can be employed without departing from the scope of the present invention.

In one embodiment, the DRS and DMC software components are highly configurable, and custom software adapters may be created to enable data in a specified format to be replicated. In addition, as illustrated by Computer 1100 in FIG. 11, the smart and/or selective synchronization techniques can be applied to multiple-computer configurations such that data from multiple computers can be replicated between each other at either proximate or remote locations.

Because each software component may be configured to interface seamlessly with other components, synchronizing data from one system to another can be performed by providing custom software adapters that package data in a manner compatible with the components. The data may then be replicated to remote locations, after which the data may be made available in the same format or it may be reformatted for use by the remote machine. In short, the smart synchronization technique analyzes the type of data being transmitted and ensures that the best algorithm is used to minimize the amount of data transfer. In addition, in some embodiments the selective synchronization technique may be used, which enables users to avoid expensive data replication techniques by allowing a user to choose what data he or she wants replicated rather than transmitting entire cumbersome data sets.

In one embodiment, the DRS and DMC software components are built using the Java J2EE protocol suite.

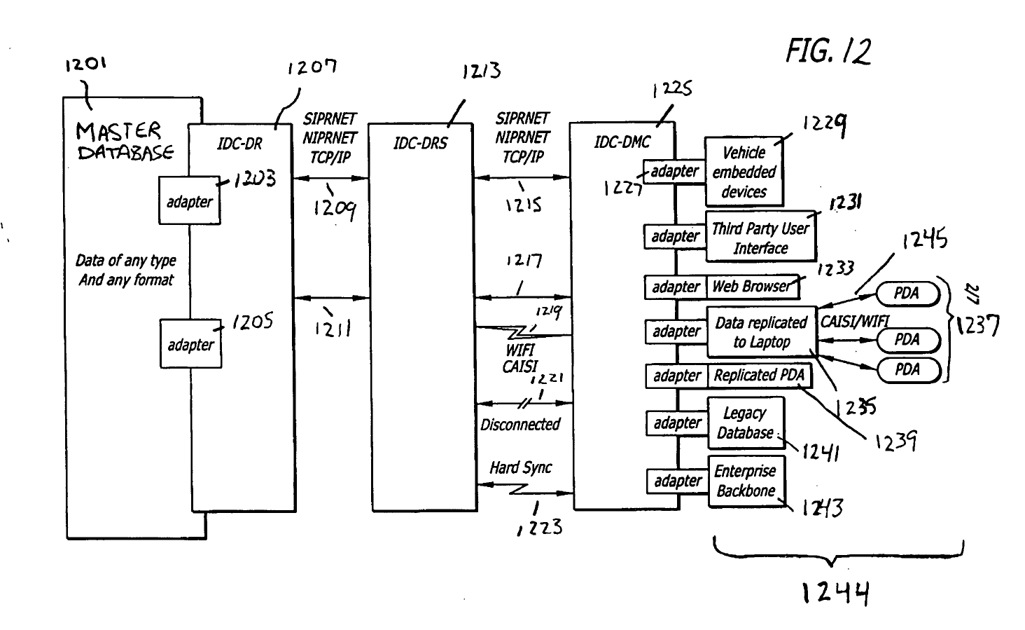

FIG. 12 is a block diagram of a data management system employing the smart synchronization techniques in accordance with an embodiment of the present invention. A master database 1201 contains data of any type and any format. The data is coupled via custom software adapters 1203 and 1205 to the data repository (DR) 1207. It is assumed for purposes of this example that DR 1207 and associated database 1201 represents the central site for the storage of documents and data in the illustrative distributed document management system. Data Repository 1207 is coupled to IDC-DRS software component 1213. In some configurations, DRS 1213 may reside on a different machine and may be coupled to DR 1207 via one or more network connections 1209 and 1211. Such network connections may include, for example, SIPRNET, NIPRNET, TCP/IP, etc. DRS 1213, in turn, is coupled to IDC-DMC software component 1225 (the functionality of which is described above), which may reside on another machine. The types of network connections may vary. Exemplary connections include SIPRNET, NIPRNET, or the TCP/IP protocol suite (illustrated by arrows 1215 and 1217), or an IEEE 802.11 WIFI wireless network connection or CAISI connection. In addition, the network may be in a disconnected mode (1221) or in hard sync mode (1223).

The example of FIG. 12 shows how a number of different types of devices and/or interfaces may function as data replication/synchronization sources or destinations. Coupled to the DMC component 1225 through appropriate software adapters 1227 are, for example, vehicle embedded devices 1229, a third party user interface 1231, a web browser 1233, a laptop 1235 and corresponding PDAs 1237 (connected to laptop 1235 via wireless connections represented by arrows 1245), a replicated PDA 1239, a legacy database 1241, or an enterprise backbone 1243. As seen in FIG. 12, the remote devices and interfaces that may take advantage of the principles of the present invention are numerous.

In FIG. 12, data is stored in master database 1201. The DM3 software securely moves data across low bandwidth and disconnected networks using smart synchronization to optimize how the data is delivered, depending on the data types in master database 1201 and, in some embodiments, the network type and properties. Thus, for example, when a synchronization request is made by any of the remote devices shown in 1244, the smart synchronization software uses an appropriate compression and synchronization algorithm for causing the data to traverse network paths 1209 and 1211, and any of the network paths described between DRS 1213 and 1225. Data replication may be bi-directional. In one illustration, a user at a web browser 1233 of a personal computer on which the IDC-DMC 1225 software component is loaded may receive data updates from master database 1201 via the DRS 1213 and the applicable network connections shown in FIG. 12. In another illustration, a user of a laptop 1235 may request data updates, which request is packaged and transmitted by the DM3 software. The data is replicated to the remote location of the laptop 1235. In still another example, the laptop computer 1235 may be coupled to Personal Digital Assistants (PDAs) 1237, and the data updates can be transferred to the PDAs 1237 via a WIFI or other appropriate network connection. Data may even be replicated to mobile vehicle embedded devices 1229, a third party user interface 1231, a legacy database 1241, or an enterprise backbone 1243. The enterprise backbone 1243 in some implementations is coupled to other devices (not shown), to and from which updated data may be transferred. In short, the document management system of the present invention need not be restricted to specific computers or machines, and the advantages of smart synchronization may be used in a variety of contexts and configurations.

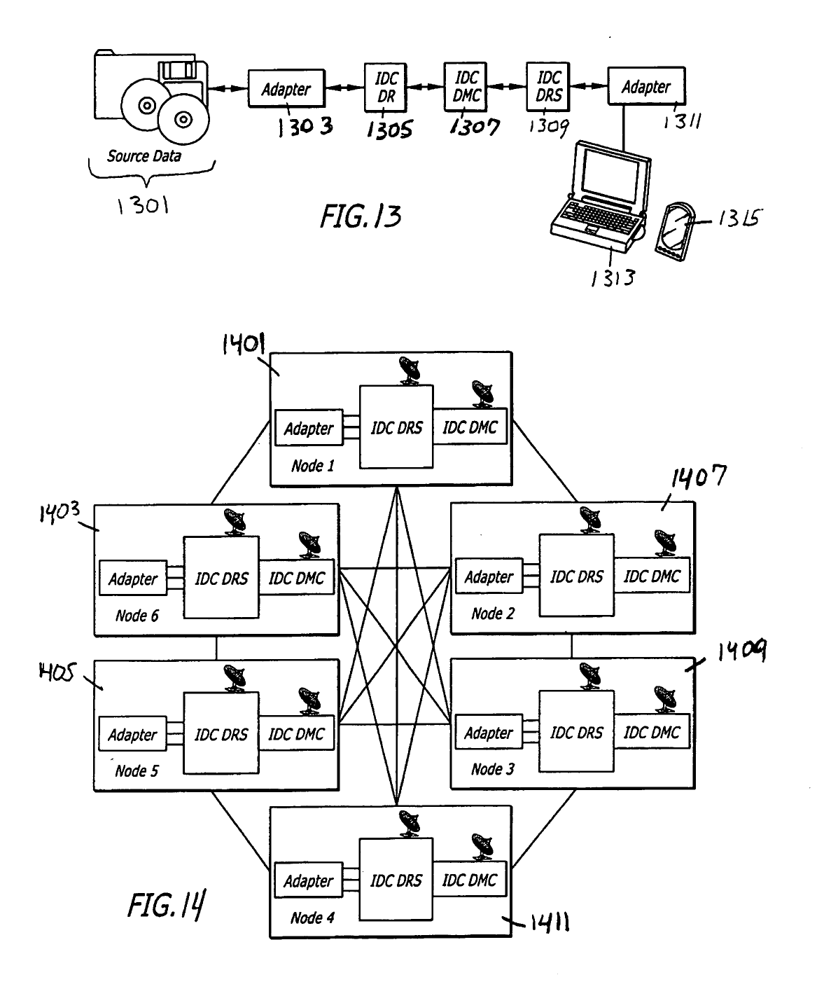

FIG. 13 is a block diagram of an exemplary system for performing smart synchronization in accordance with an embodiment of the present invention. Source data 1301 is shown in exemplary file folder, floppy disk and optical disk formats. The source data 1301 itself may be in a variety of formats, such as, for example, XML, data, PDFs, SGML, Raster formats, various database-specific formats, real time, audio data, video data, data feed formats, file systems, ERP master, or other proprietary formats. The source data may then be transferred securely to an IDC DR 1305 using any TCP/IP or other connection via an IDC software adapter 1303. Software adapter 1303 may be used to ensure compatibility between the source data 1301 and possible formats associated with IDC DR 1305.

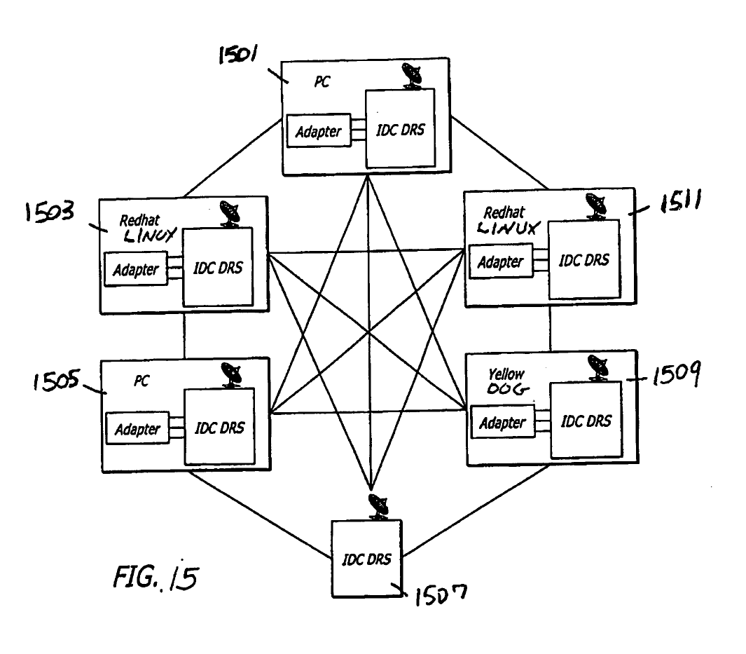

FIG. 14 is an illustrative configuration of a plurality of nodes 1401, 103. 1405. 1407, 1409 and 1411 which are part of a distributed system for performing document management operations. In this embodiment, each node runs an instance of the DMC software component. In addition, each node includes a local Data Replication Store (DRS) as well as a custom software adapter for adapting data into a format appropriate for the node. Associated with each node are a pair of satellite dishes for transmitting data and software commands from the local DMC to other nodes. Each node is coupled to each other node in a peer-to-peer configuration. One node, such as node 1401, may request a synchronization from any or all of the nodes to which node 1401 is coupled.

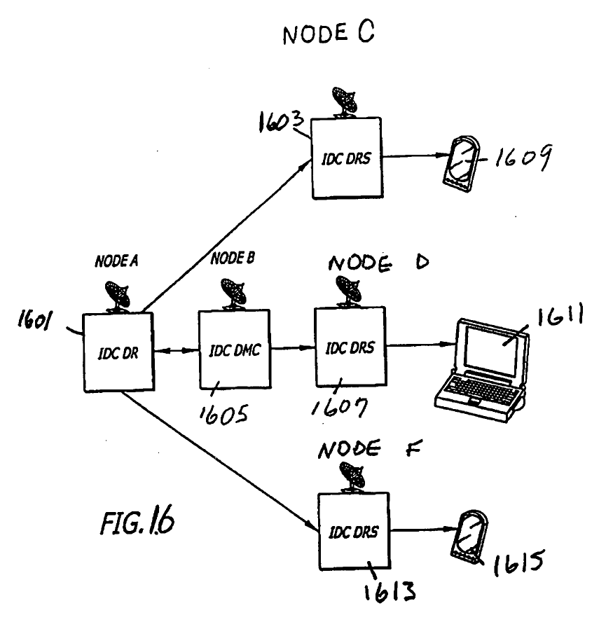

An additional advantage of the present invention is that different platforms may be run on different nodes of a distributed document management system. Reference is now made to FIG. 15, which shows a plurality of nodes 1501, 1503, 1505, 1507, 1509, and 1511 as part of a distributed document management system. Each node in this illustration is coupled with each other node, e.g., through a low bandwidth network. Node 1507 is simply a DRS node without local DMC functionality. It is assumed for purposes of this example that local components of the DMC software are run on each of the other nodes 1501, 1503, 1505, 1509 and 1511 on the different platforms associated with those nodes. For example, nodes 1501 and 1505 may constitute personal computers (PCs) running, for example, Windows XP operating system. Nodes 1503 and 1505 may constitute a workstation running Redhat Linux. Node 1509 may constitute a computer running on a Yellow Dog platform, and so forth. Through the use of the custom adapters and the mediating DMC software at the nodes, smart synchronizations may take place seamlessly despite using different platforms in this peer-to-peer configuration.

FIG. 16 shows a block diagram of another configuration of the document management system for performing smart and/or selective synchronization in accordance with an embodiment of the present invention. A centralized DMC software component 1605 runs at node B, which may include a satellite or other transmission device for transmitting and receiving data over the network. The DMC 1605 at Node B interfaces with a Data Repository (DR) 1601 and Node A. Node A also has a satellite dish for transmitting and receiving data; however, in all of these configurations, other types of network hardware are equally suitable. Node A is coupled via a network connection to a first remote Data Replication Store (DRS) 1603 and Node C. Node A is coupled to a second DRS 1613 at Node F. In addition, Node B is coupled to the DMC 1605 of Node B (and therefore may interface with the DR 1601 at Node A.

Attached to the DRS 1603 of Node C is a personal digital assistant (PDA) 1609. Attached to the DRS 1607 of Node D is a notebook computer 1611. Attached to the DRS 1613 of Node F is another PDA 16715. These three devices—1609, 1611, and 1615 can thereupon request synchronizations which are issued to the DMC component 1605 at Node B. Node B may thereupon evaluate the data to be transmitted to the remote nodes using the principles of smart synchronization, and thereupon supply updated data sets using the most efficient compression and transmission algorithms specific to the data types of those sets. Similarly, the DMC software may consider a summary of data transmitted by the synchronization request (or an ensuing or preceding request) and compare the summary with data located in the Data Repository 1601 of Node A. Using these techniques, the DMC can selectively extract the necessary data in DR 1601 and distribute it to the nodes that need it.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A method to synchronize data between a local database and a remote database over one or more networks, the method comprising:
receiving a synchronization request;
identifying data types to be synchronized;
selecting, based on the data types to be synchronized, one or more algorithms for efficiently transporting data corresponding to the data types to be synchronized over the one or more networks; and
synchronizing the data between the local database and the remote database over the one or more networks.

2. The method of claim 1 wherein the synchronization between the local database and the remote database is bi-directional.

3. The method of claim 1 wherein the selecting the one or more algorithms is based in part on parameters of the one or more networks.

4. The method of claim 1 wherein the remote database is coupled to a data replication store, and wherein the local database is coupled to a data repository.

5. The method of claim 4 wherein the identifying, selecting and synchronizing steps are performed by a data management component.

6. The method of claim 1, wherein the synchronization request comprises a summary of data updates needed by the remote database.

7. The method of claim 6, wherein the synchronizing the data includes transmitting to the remote database the data updates referenced in the summary rather than an entire data set resident in the local database.

8. The method of claim 1 wherein one of the algorithms comprises a data compression algorithm.

9. A method to synchronize data in a document management system, the document management system comprising a data repository (DR) component, a data replication store (DRS) for storing data at a location remote from the DR component, and a data management component (DMC), comprising:
receiving, from the DRS, a request to synchronize data between the DRS and the DR;
identifying, by the DMC, the types of data to be synchronized;
selecting, by the DMC, one or more algorithms for efficiently transmitting the data types to be synchronized across one or more networks to which the DR, DMC and DRS are coupled, and
synchronizing data corresponding to the data types over the network.

10. The method of claim 9 wherein a remote database is coupled to the DRS via a software adapter.

11. The method of claim 10 wherein the DR is coupled to a database via a software adapter.

12. The method of claim 9 wherein synchronization is bidirectional.

13. The method of claim 9 wherein the request received from the DRS to synchronize data comprises a summary of data updates required by the DRS.

14. The method of claim 13, wherein the synchronizing data step further includes transmitting only the data updates required by the DRS, rather than an entire data set comprising in part the required data updates.

15. A document management system comprising:
(i) a data repository (DR) component comprising a master repository for storing data;
(ii) a data replication store (DRS) component comprising one or more local data units for storing data sets, each data set originating at least in part from the data in the logical master repository and comprising information applicable to a corresponding one of the local data units; and
(iii) a data management component (DMC) comprising
(a) a synchronization service for transferring updated data from the master repository to the one or more local data units via one or more networks, wherein the synchronization service, upon request for a synchronization by the DRS, analyzes the data types to be transferred and then transmits data corresponding to the data types using one or more algorithms for efficiently transferring the data across the one or more networks.

16. The document management system of claim 15 wherein the request for synchronization further comprises a summary of updates required by the DRS.

17. The document management system of claim 16 wherein the DMC is further configured to analyze the summary and to perform the synchronization by transferring the required data updates rather than an entire data set comprising in part the data updates.

18. The document management system of claim 15 wherein the knowledge manager further comprises a global knowledge manager and a local knowledge manager.

19. The document management system of claim 15 wherein the knowledge manager further comprises a user interface to enable access by one or more of the end users.

20. The document management system of claim 15 wherein the knowledge manager further comprises an application programming interface to enable access to the knowledge manager by application programs.

21. The document management system of claim 15 wherein the data repository (DR) component further comprises a renderable object manager.

22. The document management system of claim 15 wherein the data repository (DR) component further comprises a content management system.

23. The document management system of claim 15 wherein the data repository (DR) component further comprises a user interface.

24. The document management system of claim 15 wherein the data management component (DMC) further comprises an index crawler.

25. The document management system of claim 15 wherein the knowledge manager further comprises an application programming interface (API) for permitting access by third party applications.

26. The document management system of claim 15 wherein the knowledge manager is coupled to a distribution network for distributing the updated data.

27. The document management system of claim 15 wherein the data replication store (DRS) component further comprises a connected mode coupling at least one of the data units to the data management component (DMC).

28. The document management system of claim 15 wherein at least one of the data units operates in disconnected mode.

29. The document management system of claim 15 wherein the knowledge manager further comprises an external application portal.

30. A three-tier document management system for use by an entity comprising a plurality of end user groups, the system comprising:
a data repository (DR) tier comprising a content management system for storing data in a master repository;
a data replication store (DRS) tier comprising a plurality of data units which correspond respectively to each of the plurality of end user groups; and
a data management component (DMC) tier for mediating the synchronization of data between the data repository (DR) tier and the data replication store (DRS) tier, wherein, upon request for synchronization issued from the DRS tier, the DMC tier is configured to analyze data types to be synchronized, select one or more algorithms for enabling an efficient synchronization of data over one or more networks coupling the DR tier to the DRS tier, and perform the synchronization of the data using the one or more algorithms.

31. The document management system of claim 30, wherein the one or more algorithms comprises a data compression algorithm.

32. The document management system of claim 30 wherein the data management component (DMC) tier further comprises a data repository for storing cached data applicable to one or more of the plurality of data units.

33. The document management system of claim 30 further comprising a global knowledge manager for accessing services in the master repository.

34. The document management system of claim 33 further comprising a local knowledge manager for accessing services available in at least one of the plurality of data units.

35. The document management system of claim 30 wherein the data repository (DR) tier is coupled to the data replication store (DRS) tier through a distribution channel.

36. The document management system of claim 35 wherein the distribution channel is coupled to the data management component (DMC) tier.

37. The document management system of claim 30 wherein the synchronization service is bidirectional.

38. The document management system of claim 30 wherein user profiles of the plurality of end users in the groups are created at the data management component (DMC) tier.

39. A document management system for managing the storage and transfer of data comprising:
data repository (DR) means for providing a master data repository for storing and managing data;
data replication store (DRS) means for providing one or more data units, each data unit for storing information originating at least in part from the data in the master data repository; and
data management component (DMC) means for maintaining records relevant to a state of each of the one or more data units and for performing a smart synchronization of the data in the data repository (DR) means with the information in the one or more data units in the data replication store (DRS) means.

40. The document management system of claim 39 wherein the data management component (DMC) means further comprises a configuration manager for mapping data sets to end users of the data units.

41. The document management system of claim 39 wherein the data management component (DMC) means further comprises a global knowledge manager for managing the data in the data repository (DR) means and a local knowledge manager for managing the information in the one or more data units in the data management component (DMC) means.

42. The document management system of claim 39 wherein the smart synchronization is bidirectional.

43. The document management system of claim 39 wherein the data management component (DMC) means further comprises a selective synchronization of the data in the data repository means.

44. Computer-readable media embodying a program of instructions executable by a computer program to perform a method to synchronize data between a local database and a remote database over one or more networks, the method comprising: receiving a synchronization request; identifying data types to be synchronized; selecting, based on the data types to be synchronized, one or more algorithms for efficiently transporting data corresponding to the data types to be synchronized over the one or more networks; and synchronizing the data between the local database and the remote database over the one or more networks.
